(19) United States
(12) Patent Application Publication
(10) Pub. No.: US 2006/0224633 A1
(43) Pub. Date: Oct. 5, 2006

(54) Common Import and Discovery Framework

(75) Inventors: Hesham Fahmy, Etobicoke, Ontario (CA); John H. Green, Toronto, Ontario (CA); Vladimir Klicnik, Oshawa, Ontario (CA); Norman K. W. Seto, North York, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/907,363

(22) Filed: Mar. 30, 2005

(51) Int. Cl. G06F 17/30

(52) U.S. Cl. 707/200

(57) ABSTRACT

An import framework imports metadata from any type of metadata repository using a common use case flow. At least one discovery agent associated with a metadata repository is provided. Each discovery agent is configured to implement the common use case flow required to import metadata from a respective metadata repository. Metadata is imported from a selected metadata repository using the import framework and a discovery agent associated with the selected metadata repository.

### BACKGROUND OF THE INVENTION

The present invention generally relates to application development. More particularly, the present invention provides a common import and discovery framework for authoring/generating application components using application artifacts imported from a metadata repository.

### RELATED ART

When performing application development, application artifacts are very commonly imported from a metadata repository. These metadata repositories are typically browsed for artifacts, and subsets of the artifacts are selected, from which application components are then generated. This process of selecting metadata artifacts, and generating application components from them, is referred to as metadata import. Some examples of metadata import include:

(A) Importing a WebService from a Universal Description, Discovery and Integration (UDDI) repository;

(B) Importing data types from language files and generating business objects from them. (e.g., importing a COBOL copy book and generating an XML Schema Definition (XSD) and JavaBean representation of the data types contained within);

(C) Importing functions and business objects available on Enterprise Information Systems (e.g., importing Remote Function Calls (RFCs) and Business Application Programming Interface (BAPI) objects from a SAP system); and

(D) Importing Structured Query Language (SQL) queries from a relational database.

Modern Integrated Development Environments (IDEs) provide tooling to perform the metadata import. This functionality is usually provided by a third-party having intimate knowledge of the metadata repository source. The third-party typically develops an IDE component that integrates into the Application Programming Interfaces (APIs) of the IDE and provides the functionality to generate artifacts from the metadata source. However, each metadata repository has its own interface and each IDE has its own APIs for integration. Thus for m different metadata repository types and n different IDEs, the third-party is forced to develop m×n different metadata import components.

### SUMMARY OF THE INVENTION

In general, the present invention provides a common import and discovery framework for authoring/generating application components using application artifacts imported from a metadata repository. Unlike the prior art, which requires m×n different metadata import components for m different metadata repository types and n different IDEs, only m metadata import components are required by the present invention (i.e., one metadata import component per metadata repository type, where each metadata import component can be integrated into multiple IDE environments). This allows IDEs to develop a single Graphical User Interface (GUI) and API that is independent of the metadata import provider.

The present invention allows the IDE provider to offer a single consistent usage experience for users, regardless of the metadata repository being used for generation, or the type of program artifacts being generated. It also allows the IDE provider to only write one set of program logic, yet be able to support an endless variety of metadata import scenarios. This support can also change over time by the addition of components that plug into this unified program logic. These components can be offered by the IDE provider, or by other third-party vendors. These pluggable components are referred to as discovery agents.

A first aspect of the present invention is directed to a method for importing metadata, comprising: providing an import framework for importing metadata from any type of metadata repository using a common use case flow; providing at least one discovery agent, wherein each discovery agent is associated with a metadata repository, and wherein each discovery agent is configured to implement the common use case flow required to import metadata from a respective metadata repository; and importing metadata from a selected metadata repository using the import framework and a discovery agent associated with the selected metadata repository.

A second aspect of the present invention is directed to a system for importing metadata, comprising: an import framework for importing metadata from any type of metadata repository using a common use case flow; at least one discovery agent, wherein each discovery agent is associated with a metadata repository, and wherein each discovery agent is configured to implement the common use case flow required to import metadata from a respective metadata repository; and means for importing metadata from a selected metadata repository using the import framework and a discovery agent associated with the selected metadata repository.

A third aspect of the present invention is directed to a program product stored on a computer readable medium for importing metadata, the computer readable medium comprising program code for performing the following steps: providing an import framework for importing metadata from any type of metadata repository using a common use case flow; providing at least one discovery agent, wherein each discovery agent is associated with a metadata repository, and wherein each discovery agent is configured to implement the common use case flow required to import metadata from a respective metadata repository; and importing metadata from a selected metadata repository using the import framework and a discovery agent associated with the selected metadata repository.

A fourth aspect of the present invention provides a method for importing metadata, comprising: providing an Integrated Development Environment (IDE) including an import framework for importing metadata from any type of metadata repository using a common use case flow; providing a first discovery agent for importing metadata from a first metadata repository, wherein the first discovery agent is configured to implement the common use case flow; and importing metadata from the first metadata repository to the IDE using the import framework and the first discovery agent.

A fifth aspect of the present invention provides a method for deploying an application for importing metadata, comprising: providing a computer infrastructure being operable to: provide an import framework for importing metadata from any type of metadata repository using a common use case flow; provide at least one discovery agent, wherein each discovery agent is associated with a metadata repository, and wherein each discovery agent is configured to implement the common use case flow required to import metadata from a respective metadata repository; and import metadata from a selected metadata repository using the import framework and a discovery agent associated with the selected metadata repository.

A sixth aspect of the present invention provides computer software embodied in a propagated signal for importing metadata, the computer software comprising instructions to cause a computer system to perform the following functions: provide an import framework for importing metadata from any type of metadata repository using a common use case flow; provide at least one discovery agent, wherein each discovery agent is associated with a metadata repository, and wherein each discovery agent is configured to implement the common use case flow required to import metadata from a respective metadata repository; and import metadata from a selected metadata repository using the import framework and a discovery agent associated with the selected metadata repository.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a flow diagram of a common use case flow for metadata import in accordance with an embodiment of the present invention.

FIG. 2 depicts a system for implementing the common use case flow of FIG. 1 in accordance with an embodiment of the present invention.

FIG. 3 depicts the initialize step of the common use case flow of FIG. 1 in greater detail.

FIG. 4 depicts the query step of the common use case flow of FIG. 1 in greater detail.

FIG. 5 depicts the select results step of the common use case flow of FIG. 1 in greater detail.

FIG. 6 depicts the import selected results step of the common use case flow of FIG. 1 in greater detail.

FIG. 7 depicts the generate application artifacts from imported results step of the common use case flow of FIG. 1 in greater detail.

FIG. 8 depicts an IDE that allows multiple discovery agents to plug into its environment in accordance with an embodiment of the present invention.

FIG. 9 depicts an illustrative computer system for implementing the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a common import and discovery framework for authoring/generating application components using application artifacts imported from a metadata repository.

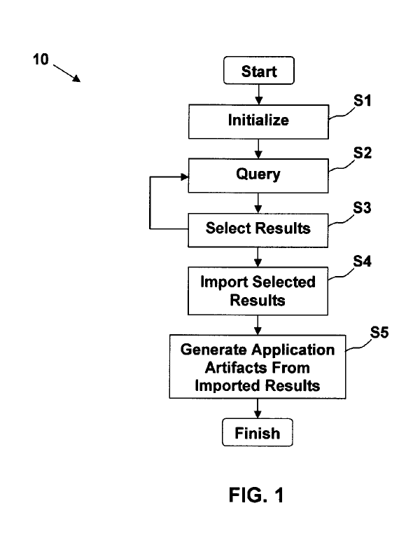

For each metadata repository type, there are different parameters and flow of user input required to drive a metadata import. The present invention, however, recognizes that nearly all types of metadata imports can be generalized into a common use case flow 10 as depicted in FIG. 1, regardless of what type of metadata is being imported. As shown in FIG. 1, the common use case flow 10 includes the following steps:

Step S1: Initialize;

Step S2: Query;

Step S3: Select Results;

Step S4: Import Selected Results; and

Step S5: Generate Application Artifacts From Imported Results.

The present invention reduces any type of metadata import scenario into this basic flow, regardless of what type of metadata is being imported.

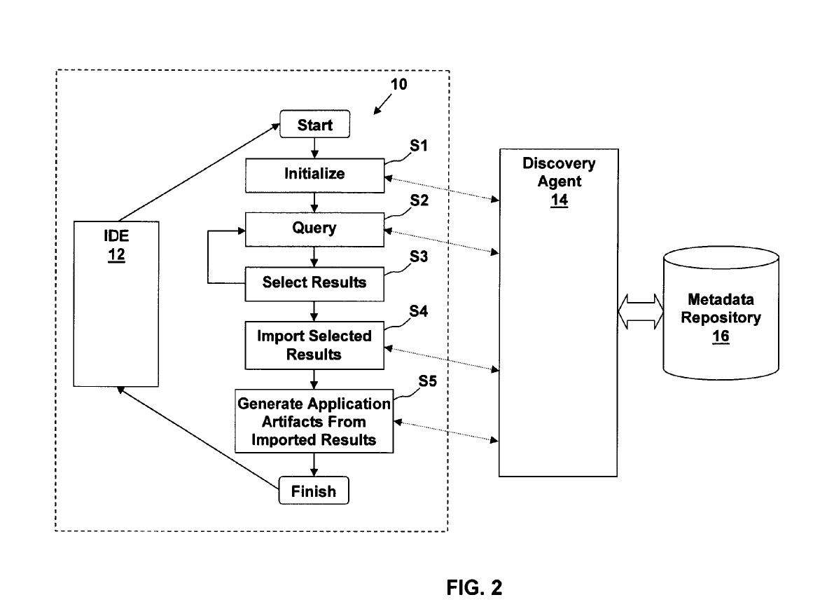

Applying the common use case flow 10 across all metadata imports, one can generalize the user interface that an IDE needs to provide to support metadata import functionality. As shown in FIG. 2, for example, an IDE 12 can provide its own implementation of a UI that drives the core five tasks (i.e., steps S1-S5) identified in the common use case flow 10. Third-parties would be able to plug their metadata import functionality into the IDE by providing a discovery agent 14 that provides the implementation required behind each one of the tasks in the common use case flow 10. To this extent, each discovery agent 14 serves as an intermediary between the IDE 12 and a respective metadata repository 16. It should be noted more than one discovery agent 14 can be associated with the same metadata repository 16.

In most of the steps of the common use case flow 10, a set of user input needs to be provided to each discovery agent 14. For example, in the query step (step S2), each discovery agent 14 can have a different set of parameters that are used to define a query on the corresponding metadata repository 16. In accordance with the present invention, the exchange of user input information preferably occurs using a canonical UI format. Other techniques for exchanging user input information can also be used. The discovery agent 14 supplies a UI declaration in this canonical form and the IDE 12 is responsible for rendering the UI to the user and collecting the appropriate input parameters. Some examples of canonical UI representations include:

(A) HyperText Markup Language (HTML) forms;

(B) Extensible HyperText Markup Language (XHTML) forms;

(C) XForms; and

(D) PropertyEditor support provided in the java.beans J2SE Development Kit (JDK) package.

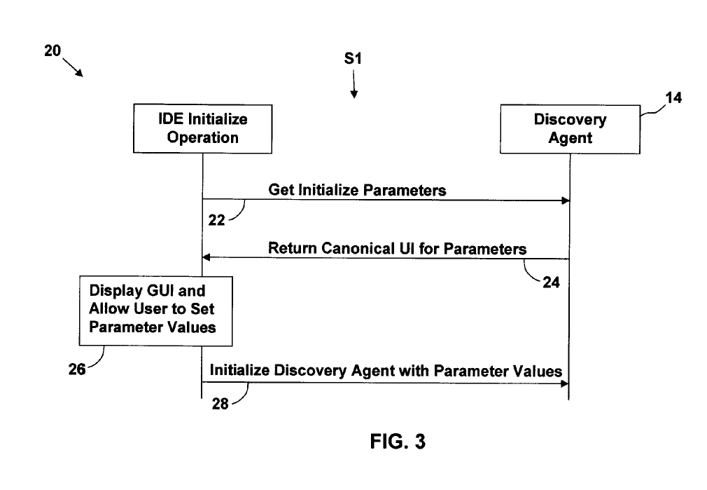

Steps S1-S5 will be described in greater detail below with reference to FIGS. 3-7.

Initialize

As shown in FIG. 3, for the initialize step (step S1), an IDE generic interface 20 first asks 22 the discovery agent 14 for its set of initialize parameters. In response, the discovery agent 14 returns 24 a listing of the initialize parameters it requires in a canonical UI form. The IDE generic interface 20 displays 26 the listing of initialize parameters required by the discovery agent 14 to the user in a GUI and allows the user to set the desired values. The IDE generic interface 20 then initializes 28 the discovery agent 14 with the values set by the user. At this point, the discovery agent 14 is responsible for performing any required setup procedures to prepare the metadata repository 16 for selection and import of data.

Each discovery agent 14 generally requires a different set of initialize parameters, based on its intended function. For example, the initialize parameters of a discovery agent 14 for importing a COBOL file from a metadata repository 16 may comprise information required for loading the file (e.g., name/location of the file within the metadata repository 16). For a discovery agent 14 configured to browse an SAP system, however, the initialize parameters required by the discovery agent 14 may comprise information for initializing a connection to the SAP system.

Query

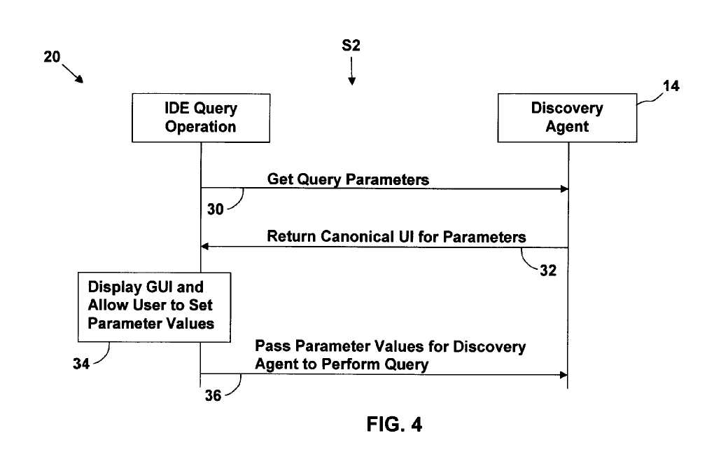

As shown in FIG. 4, for the query step (step S2), the IDE generic interface 20 first asks 30 the discovery agent 14 for its set of query parameters. The query parameters represent the information required by the discovery agent 14 to form a query against the metadata repository 16. In response, the discovery agent 14 returns 32 a listing of the query parameters it requires in a canonical UI form. The IDE generic interface 20 displays 34 the listing of query parameters to the user in a GUI and allows the user to set the desired values. The IDE generic interface 20 then requests 36 the discovery agent 14 to perform a query, with the set values, against the metadata repository 16.

Select Results

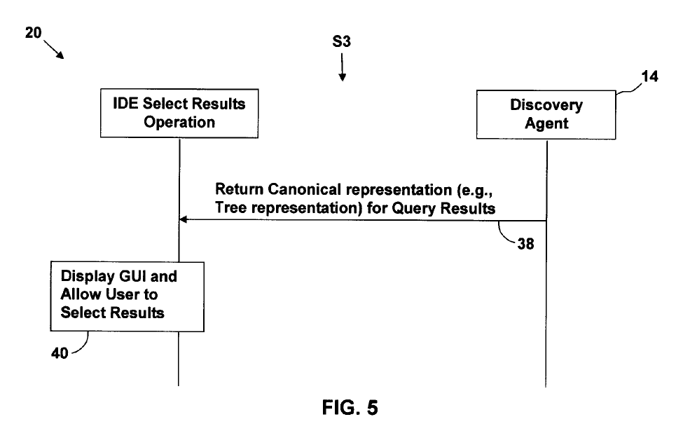

As shown in FIG. 5, after performing the query step (step S2), the discovery agent 14 returns 38 the results for the query to the IDE generic interface 20 in the select results step (step S3). The results, which represent metadata artifacts, are returned to the IDE generic interface 20 using a canonical UI representation. One example of a suitable canonical UI representation comprises a canonical tree representation. Other suitable now known or later developed canonical UI representations can also be used to display the results returned in the select results step. The IDE generic interface 20 displays 40 the canonical UI representation of the results of the query to the user, who is then asked to select the portions of the canonical UI representation (e.g., the nodes of the tree) that are desired for import as application artifacts.

If the user is unsatisfied with the results of the query, he/she may wish to perform the query again using modified query parameters. In this case, the IDE generic interface 20 can return to the query step (step S2).

Import Selected Results

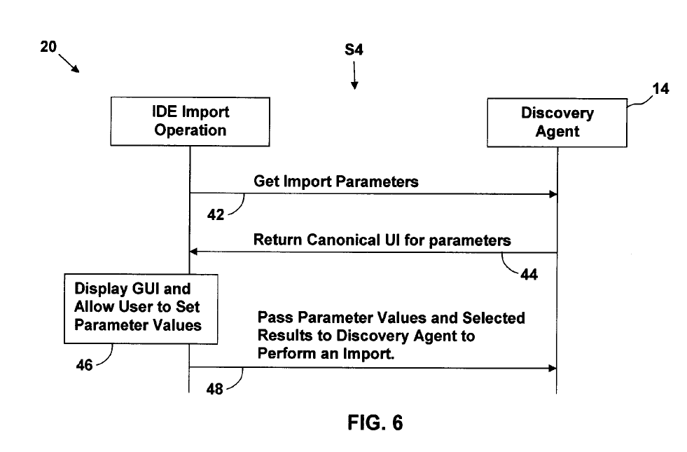

As shown in FIG. 6, for the import selected results step (step S4), the IDE generic interface 20 first asks 42 the discovery agent 14 for its set of import parameters. The import parameters represent any additional information required to import data from the metadata repository 16. The discovery agent 14 returns 44 the import parameters in a canonical UI form. The IDE generic interface 20 displays 46 the import parameters to the user in a GUI and allows the user to set the desired values. The IDE generic interface 20 then requests 48 the discovery agent to perform an import, with the set values, against the metadata repository 16. Along with this request, the IDE generic interface 20 also passes the portions of the canonical representation that are desired for import as application artifacts, selected by the user in step S3. At this point, the discovery agent 14 is responsible for performing the necessary operations to extract the selected metadata from the metadata repository 16.

Generate Application Artifacts From Imported Results

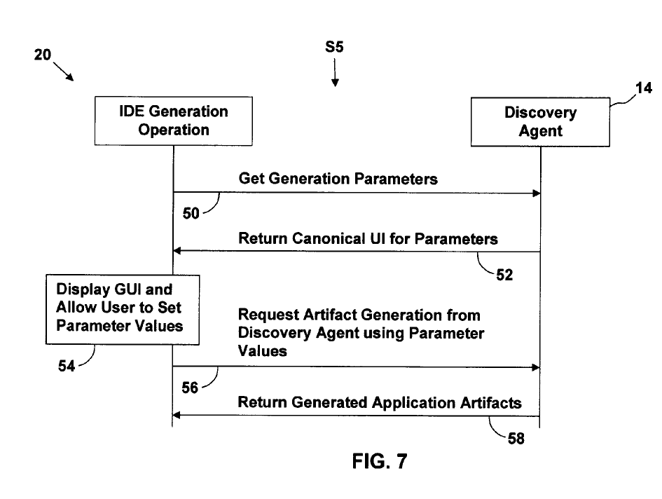

As shown in FIG. 7, for the generation step (step S5), the IDE generic interface 20 asks 50 the discovery agent 14 for its set of generation parameters. The generation parameters represent the information required to generate specific application artifacts from the metadata imported from the metadata repository 16. The discovery agent 14 returns 52 the generation parameters in a canonical UI form. The IDE generic interface 20 displays 54 the generation parameters to the user in a GUI and allows the user to set the desired values. The IDE generic interface 20 then requests 56 the discovery agent 14 to generate artifacts, with the set values, against the metadata repository 16. The discovery agent 14 is responsible for transforming the imported metadata, from the previous step (step S4), into the requested application artifacts. The discovery agent 14 returns 58 the set of generated artifacts upon completion of this step. For example, the set of generated artifacts can be returned by the discovery agent 14 as sets of binary data that the IDE 12 writes into separate files.

Discovery Agent Examples

Below are two examples of metadata import, and how they can be represented as discovery agents.

Enterprise Information Systems (such as SAP and PeopleSoft) contain a rich set of metadata describing the functions, and data types, available on the system. Furthermore, most of these systems can be accessible in a Java 2 Enterprise Edition (J2EE) environment using J2EE Resource Adapter. It is often desirable to be able to import the Enterprise Information System (EIS) metadata, and generate from it a set of Java classes and JavaBeans. These generated Java classes allow an application to invoke the functions on the EIS system, using an appropriate J2EE Resource Adapter. An illustrative technique for constructing an EIS discovery agent in accordance with an embodiment of the present invention is as follows:

(a) In the initialize phase, the set of initialize parameters are the connection parameters that the appropriate J2EE Resource Adapter requires to connect to the EIS. Upon initialization, the discovery agent uses the J2EE Resource Adapter to create a physical connection to the EIS system.

(b) In the query phase, the set of query parameters correspond to the query parameters that the EIS metadata repository provides. To perform a query, the discovery agent uses the J2EE Resource Adapter to perform a J2EE Connector Architecture Interaction with the EIS system. The interaction comprises a function call to search the metadata content of the EIS.

(c) In the import phase, the discovery agent also performs an interaction with the EIS system. However, this interaction is a function call to retrieve the metadata content of the EIS.

(d) In the generation phase, the set of generation parameters comprises the desired names, and packages, for the generated Java classes. For generation, the discovery agent then converts the EIS metadata into JavaBean classes to represent the EIS data types, and Java classes to invoke the EIS functions.

Many legacy systems use legacy programming languages such as COBOL and PL/I. In modern application integration systems it is often desirable to be able to communicate with these legacy systems. To do so, applications must mirror the data types defined on these systems. Application developers must import the legacy language files and generate modern data type definitions from them. Below is an example of how a discovery agent can be written to perform an import of a COBOL program definition, and generate from it an XML schema representation of the data types:

(a) In the initialize phase, the initialize parameter is the location of the COBOL file (e.g., COBOL copy book definition). Upon initialization, the discovery agent locates the specified file and opens it for reading.

(b) In the Query phase, the set of query parameters correspond to the nature of the target system the COBOL program is running on. This will impact the way the COBOL file will be viewed (e.g., what codepage should be used to view the file). The result of the query could be a tree structure representing the hierarchy of data types found in the COBOL file.

(c) In the import phase, the discovery agent generates an internal model representation of the desired COBOL data types.

(d) In the generation phase, the set of generation parameters comprise the desired names and namespaces for the XML Schema files. The discovery agent transforms the internal model of the COBOL data types into corresponding XML schema files.

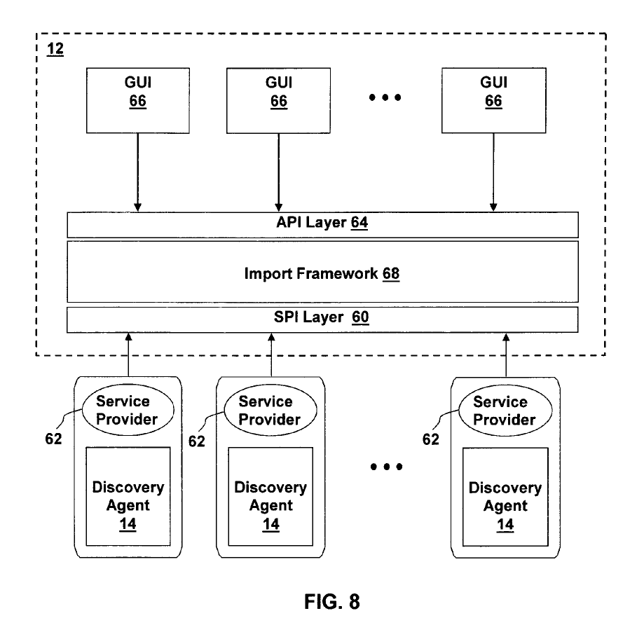

In the embodiment depicted in FIG. 8, the present invention comprises an IDE 12 that allows multiple discovery agents 14 plug into its environment. The IDE 12 provides a Service Provider Interface (SPI) layer 60 that allows discovery agent server providers 62 to register themselves as providers of a metadata import service to the IDE 12. The IDE 12 also provides an Application Programming Interface (API) layer 64 which allows various GUI's 66 to interact with the available discovery agents 14. The IDE 12 further includes an import and discovery framework 68 for implementing the common use case flow 10 detailed above.

This embodiment of the present invention allows multiple GUI's 66 to interact with multiple discovery agents 14 in a generic fashion (i.e., the implementation and logic of the GUI interfaces 66 is independent of the type of metadata import provided by the available discovery agents 14). It also allows a dynamic environment for the adding, and removing, of metadata import functionality by manipulating the set of registered discovery agents 14 available at any given time.

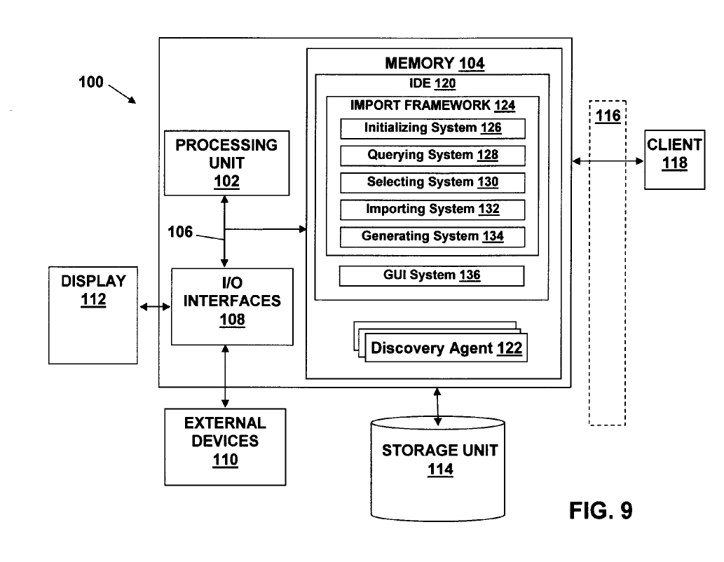

A computer system 100 for providing a common import and discovery framework in accordance with an embodiment of the present invention is depicted in FIG. 9. Computer system 100 generally includes a processing unit 102, memory 104, bus 106, input/output (I/O) interface(s) 108, and external devices/resource(s) 110. Processing unit 102 may comprise a single processing unit, or may be distributed across one or more processing units in one or more locations. Memory 104 may comprise any known type of data storage and/or transmission media, including magnetic media, optical media, random access memory (RAM), read-only memory (ROM), etc. Moreover, similar to processing unit 102, memory 104 may reside at a single physical location, comprising one or more types of data storage, or be distributed across a plurality of physical systems in various forms.

I/O interface(s) 108 may comprise any system for exchanging information to/from an external source. External devices/resource(s) 110 may comprise any known type of external device, including speakers, a CRT, LCD screen, handheld device, keyboard, mouse, voice recognition system, speech output system, printer, monitor/display (e.g., display 112), facsimile, pager, etc.

Bus 106 provides a communication link between each of the components in computer system 100, and likewise may comprise any known type of transmission link, including electrical, optical, wireless, etc. In addition, although not shown, additional components, such as communication systems, system software, etc., may be incorporated into computer system 100.

Data (e.g., metadata) used in the practice of the present invention can be stored locally to computer system 100, for example, in storage unit 114, and/or may be provided to computer system 100 over a network 116. Storage unit 114 can be any system capable of providing storage for data and information under the present invention. As such, storage unit 114 may reside at a single physical location, comprising one or more types of data storage, or may be distributed across a plurality of physical systems in various forms. In another embodiment, storage unit 114 may be distributed across, for example, a local area network (LAN), wide area network (WAN) or a storage area network (SAN) (not shown).

Network 116 is intended to represent any type of network over which data can be transmitted. For example, network 116 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server. One or more client devices 118 may be connected to computer system 100 via network 116. Each client device 118 comprises components similar to those described above with regard to computer system 100.

Shown in memory 104 (e.g., as computer program products) are an IDE 120 and at least one discovery agent 122 for importing application artifacts from one or more different metadata repositories (e.g., storage unit 14). IDE 120 includes an import framework 124 for implementing the common use case flow 10 of the present invention. Import framework 124 includes an initializing system 126, a querying system 128, a selecting system 130, an importing system 132, and a generating system 134 for providing the functionality required by steps S1-S5, respectively, of the common use case flow 10 shown in FIG. 1. Also provided in IDE 120 is a GUI system 136 for displaying the various canonical UI forms, canonical representations, etc., provided by each discovery agent 122 on the display 112.

It should be appreciated that the teachings of the present invention can be offered as a business method on a subscription or fee basis. For example, one or more components of the present invention could be created, maintained, supported, and/or deployed by a service provider that offers the functions described herein for customers. That is, a service provider could be used to provide a common import and discovery framework, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for importing metadata, comprising:
providing an import framework for importing metadata from any type of metadata repository using a common use case flow;
providing at least one discovery agent, wherein each discovery agent is associated with a metadata repository, and wherein each discovery agent is configured to implement the common use case flow required to import metadata from a respective metadata repository; and
importing metadata from a selected metadata repository using the import framework and a discovery agent associated with the selected metadata repository.

2. The method of claim 1, wherein the common use case flow comprises a predetermined set of steps for importing metadata from a metadata repository, and wherein each discovery agent provides an implementation of each of the steps of the common use case flow.

3. The method of claim 2, wherein the predetermined set of steps include the step of:
initializing the discovery agent.

4. The method of claim 3, wherein the step of initializing the discovery agent further comprises:
requesting a set of initialize parameters from the discovery agent;
receiving from the discovery agent a listing of the initialize parameters it requires;
setting values for the initialize parameters required by the discovery agent; and
initializing the discovery agent using the selected values for the initialize parameters.

5. The method of claim 4, wherein the listing of the initialize parameters the discovery agent requires is provided in a canonical user interface (UI) form; and wherein the step of setting values for the initialize parameters required by the discovery agent further comprises:
displaying the canonical UI form in a graphical user interface (GUI).

6. The method of claim 2, wherein the predetermined set of steps include the step of:
querying the metadata repository for metadata.

7. The method of claim 6, wherein the step of querying the metadata repository further comprises:
requesting a set of query parameters from the discovery agent;
receiving from the discovery agent a listing of the query parameters it requires;
setting values for the query parameters required by the discovery agent;
passing the set values for the query parameters to the discovery agent; and
querying the metadata repository using the set values for the query parameters.

8. The method of claim 7, wherein the listing of the query parameters the discovery agent requires is provided in a canonical user interface (UI) form; and wherein the step of setting values for the query parameters required by the discovery agent further comprises:
displaying the canonical UI form in a graphical user interface (GUI).

9. The method of claim 6, wherein the predetermined set of steps include the step of:
selecting results of the query of the metadata repository for import.

10. The method of claim 9, wherein the step of selecting results of the query of the metadata repository further comprises:
receiving from the discovery agent the results of the query of the metadata repository; and
selecting a set of the results of the query of the metadata repository for import.

11. The method of claim 10, wherein the results of the query of the metadata repository is provided by the discovery agent in a canonical user interface (UI) representation; and wherein the step of selecting values of the query of the metadata repository for import further comprises:
displaying the canonical UI representation in a graphical user interface (GUI).

12. The method of claim 10, wherein the predetermined set of steps include the step of:
importing the selected set of results of the query from the metadata repository.

13. The method of claim 12, wherein the step of importing the selected results of the query from the metadata repository further comprises:
requesting a set of import parameters from the discovery agent;
receiving from the discovery agent a listing of the import parameters it requires;
setting values for the import parameters required by the discovery agent;
passing the set values for the import parameters and the selected set of the results of the query of the metadata repository to the discovery agent; and
importing the selected set of the results of the query from the metadata repository.

14. The method of claim 13, wherein the listing of the import parameters the discovery agent requires is provided in a canonical user interface (UI) form; and wherein the step of setting values for the import parameters required by the discovery agent further comprises:
displaying the canonical UI form in a graphical user interface (GUI).

15. Deploying an application for importing metadata, comprising:
providing a computer infrastructure being operable to perform the method of claim 1.

16. Computer software embodied in a propagated signal for importing metadata, the computer software comprising instructions to cause a computer system to perform the method of claim 1.

17. A method for importing metadata, comprising:
providing an Integrated Development Environment (IDE) including an import framework for importing metadata from any type of metadata repository using a common use case flow;
providing a first discovery agent for importing metadata from a first metadata repository, wherein the first discovery agent is configured to implement the common use case flow; and
importing metadata from the first metadata repository to the IDE using the import framework and the first discovery agent.

18. The method of claim 17 further comprising:
providing a second discovery agent for importing metadata from a second metadata repository, wherein second discovery agent is configured to implement the common use case flow; and
importing metadata from second metadata repository to the IDE using the import framework and the second discovery agent.

19. A system for importing metadata, comprising:
an import framework for importing metadata from any type of metadata repository using a common use case flow;
at least one discovery agent, wherein each discovery agent is associated with a metadata repository, and wherein each discovery agent is configured to implement the common use case flow required to import metadata from a respective metadata repository; and
means for importing metadata from a selected metadata repository using the import framework and a discovery agent associated with the selected metadata repository.

20. A program product stored on a computer readable medium for importing metadata, the computer readable medium comprising program code for performing the following steps:
providing an import framework for importing metadata from any type of metadata repository using a common use case flow;
providing at least one discovery agent, wherein each discovery agent is associated with a metadata repository, and wherein each discovery agent is configured to implement the common use case flow required to import metadata from a respective metadata repository; and
importing metadata from a selected metadata repository using the import framework and a discovery agent associated with the selected metadata repository.
